(19) United States
(12) Patent Application Publication
(10) Pub. No.: US 2013/0317868 A1
(43) Pub. Date: Nov. 28, 2013

(54) Inventory Management Platform and Systems and Methods for Using Same

(71) Applicants: William Diamond, New York (NY); John Wagner, New York, NY (US)

(72) Inventors: William Diamond, New York (NY); John Wagner, New York, NY (US)

(73) Assignee: LOYAL FAN LLC, Mount Kisco, NY (US)

(21) Appl. No.: 13/894,897

(22) Filed: May 15, 2013

Related U.S. Application Data
(60) Provisional application No. 61/650,551, filed on May 23, 2012.

(51) Int. Cl. G06Q 10/02

(52) U.S. Cl. CPC G06Q 10/02
USPC 705/5

(57) ABSTRACT

Systems, methods and computer program products that facilitate the sale of perishable inventory such as tickets to a limited capacity event are provided. Through the targeting of fans who are interested in access to the perishable inventory and are within a geographic location that permits them to go to an event location within a limited amount of time, there can be increased attendance at the events. Optionally, a fan's passion level can be considered when determining whether to make an offer.

### CROSS-REFERENCE TO RELATED APPLICATION

This application claims the benefit of the filing date of U.S. Provisional Application Ser. No. 61/650,551, filed May 23, 2012, the entire disclosure of which is incorporated by reference as if set forth fully herein.

### FIELD OF THE INVENTION

The present invention is directed to the field of selling tickets for an event.

### BACKGROUND OF THE INVENTION

Many people enjoy attending sporting contests, musical events and the theater. Typically, in order to attend one of these events, a person needs to purchase a ticket. Both for safety reasons and in order to promote maximal enjoyment by patrons, frequently only a limited number of tickets are offered for sale. When there are only a finite number of tickets that are available for an event, the event may be referred to as “a limited capacity event.”

Performers and venue operators who host these events prefer to have a full house, i.e., to sell all tickets and to have all ticketholders attend. By having a full house, the maximum amount of revenue is generated and the popularity of the event is confirmed.

Unfortunately, for at least three reasons selling tickets for all seats and having maximum attendance is not always possible. First, many people are reluctant to commit to purchasing tickets far in advance because, at the time that they learn of an event, they do not know their availability, and by the time that they do know their availability, they may not remember that the event is going to take place. Second, many people who are interested in attending an event do not attend because they do not want to pay the asking price for a ticket. Third, there is always a segment of ticketholders who, due to unforeseen circumstances, are not able to use the tickets that they have purchased, i.e., there are no-shows.

Regardless of the reasons for selling fewer than all tickets or having less than a full house at an event, there remains a need for means by which to bring attendance as close to one hundred percent as possible. The present invention is directed to this need.

### SUMMARY OF THE INVENTION

Systems, methods and computer program products that facilitate the sale of perishable inventory such as tickets to a limited capacity event are provided. Through the targeting of fans who are interested in access to the perishable inventory and are within a geographic location that permits them to get to an event location within a limited amount of time, there can be increased attendance at the event.

According to one embodiment, the present invention provides a method for selling ticket inventory to an event, wherein the method comprises: (a) determining an inventory of tickets for an event for which at time T1, no ticketholder has indicated that he or she will be in attendance at the event, wherein the event is scheduled for an event time T2 at an event location, wherein T2 is after T1; (b) determining a set of potential attendees for the event; (c) transmitting an offer for tickets to the event to a subset of potential attendees, wherein the subset is defined at least in part based on a geographic distance from the event; and (d) receiving an acceptance of the offer from at least one of the subset of potential attendees. Optionally, the acceptance comprises an identification of a specific number of tickets. This method may, for example, be carried out with a computer system, and each step may be carried out via one or more computer programs that are executing on computer equipment and that are stored in part or in total on a non-transitory storage medium or in a computing cloud.

According to a second embodiment, the present invention provides a computer program product comprising a computer readable storage medium having computer useable program code embodied therewith, wherein the computer useable program code is stored on a non-transitory medium that upon being executed by a processor is operable: (a) to collect a first set of data related to a set of tickets for a limited capacity event; (b) to collect a second set of data related to confirmed attendance of ticketholders for the limited capacity event; (c) to determine a third set of data related to tickets for which attendance for the limited capacity event has not been confirmed; (d) to disseminate information corresponding to the third set of data to a plurality of persons on their mobile devices, at a predetermined amount of time prior to the start of the limited capacity event, wherein the plurality of persons is defined, at least in part, by their geographic location; and (e) to receive from at least one of the plurality of persons an indication that the at least one person would like to purchase at least one ticket for the limited capacity event.

According to a third embodiment, the present invention provides a method for targeting offers for commercial transactions relating to a good, a service or an opportunity comprising: (a) determining a set of potential customers for a good, a service or an opportunity; (b) analyzing data associated with a plurality of persons within the set of potential customers, wherein said analyzing comprises generating a passion score by an algorithm for measuring passion, wherein the algorithm comprises at least one variable selected from the group consisting of activity in social media pertaining to the good, the service or the opportunity; transmission of messages pertaining to the good, the service or the opportunity; visits to websites pertaining to the good, the service or the opportunity; and prior purchases of the same or similar goods, services or opportunities; (c) identifying a set of fans from within the set of potential customers to whom to make an offer for the good, the service or the opportunity that is defined in whole or in part as either a predetermined number of fans who have the top passion scores or a predetermined percentage of fans who have the top passion scores; and (d) transmitting the offer to the set of fans identified in (c).

By using the technologies of the present invention, various efficiencies may be increased. In certain embodiments, one or more aspects of the present invention are automated and carried out with computerized technologies on general machines or on specially designed machines. Furthermore, in various embodiments data is collected, analyzed and transformed.

### BRIEF DESCRIPTION OF THE FIGURE

FIG. 1 is a flow diagram that represents one embodiment of the use of an inventory management platform of the present invention.

### DETAILED DESCRIPTION OF THE INVENTION

Reference will now be made in detail to various embodiments of the present invention, an example of which is illustrated in the accompanying figure. In the following detailed description, numerous specific details are set forth in order to provide a thorough understanding of the present invention. However, unless otherwise indicated, the details are intended to be examples and should not be deemed to limit the scope of the invention in any way.

Various embodiments of the present invention are directed to methods, systems and computer program products for managing inventory for a limited capacity event. A number of these systems have three components: (1) a core application that resides on a customer's mobile device, e.g., a mobile phone such as an Android, I-phone, or Blackberry; (2) a protocol for aggregating data from the core application and for storing a customer's account information; and (3) an inventory management platform that is built on top of the aforementioned protocol and enables an entity, e.g., a sports team, a league, a music venue, a theater or a band, to offer perishable inventory to persons who may have an interest in purchasing that perishable inventory. By way of a non-limiting example, “perishable inventory” may be access (e.g., tickets) to an event that commences at or about a specific time on a specific day and optionally a finite duration.

The core application may be configured to be operable by a user through a graphic user interface, e.g., a touch screen, a keyboard, a mouse, a joystick, or a combination thereof. Alternatively or additionally, the application may be accessible through voice activated technologies. A consumer may acquire this application for free, for a one-time charge or as part of a subscription. The application is designed to be able to receive information over a network and to transmit information over a network. It may enable communication over the network through one or more portals, and the network may be wired or wireless.

The core application may also be configured to communicate with non-transitory memory or a memory module on the device. The memory may, for example, contain data related to purchasing, e.g., credit card information such as a credit card number and expiration date. The memory may also contain information such as past purchasing activity and/or purchasing preferences, e.g., number and/or location of seats. Furthermore, the core application may itself contain security features such as, password protection that prevents unauthorized users from accessing the application.

By way of a non-limiting example, a user who downloads the application may be asked to select one or more sports of which he or she is a fan and one more teams within that sport. By indicating of what a user is a fan, the system can better determine which offers to make to the user. The user may also be prompted to look for other fans on social networking sites such as Facebook who are fans of the same teams and then friend them through the application. Similarly, the user may be prompted to search within his or her address books for various e-mail accounts for other persons who are fans of the same teams. Preferably, these contacts have also already downloaded the same application and denoted of what they are fans. In some embodiments, the application offers the choice of searching for all fans of the same teams, or applying a filter to search only for fans within the user's contacts or within a geographic radius that the user chooses or is chosen for him or her. Optionally, the system may ask a user for an identification of persons who do not have access to the application but might be interested in the application, and then facilitate sending offers directly to these persons on how to obtain the application.

The application may also allow the user to check-in and thereby provide notice of his or her location. Notice may provide at least two functions. First, it allows the system to determine where the user is at a given time in order to determine whether to make an offer. Second, it allows other fans who are close by to find the user. For example, if two fans have checked-in at a restaurant, each may be provided with notice of the other's presence there so that they can meet each other. This feature may be particularly attractive for fans who are supporting an away team, i.e., a team that is not in its hometown.

The protocol for aggregating data may be located in a cloud in a non-transitory storage device (e.g., a non-cache media) or as part of a network. The protocol manages customer data and may have been constructed through an application programming interface that is part of a software development kit. Thus, through this protocol, the location, the seating preferences and the methods of payment for each customer may be tracked as well as aggregated.

The protocol may be the means by which a fan's location is tracked. For example, as noted above a customer may check-in to the system by activating an application that tells the system where he or she is. In some embodiments, the user may first be asked to allow the system determine his or her location through global positioning satellite technology, and the system may then make the determination of the location of the person only after being granted the permission to do so. The system may then provide the user with the option of confirming the location as determined by the system. The system may also be configured such that if at any time a user does not grant permission to have his or her location determined by the system, the system will assume that the user is at the last location at which the user checked-in.

In some embodiments, upon downloading the application, the user may grant the system the right to make determinations of the user's location at regular or irregular intervals, without requiring the user to actively check-in. If the system makes such a determination, and the fan also identifies a location, but the location determined by the system is different from the location noted by the fan, the system may send a query about the inconsistency and ask the fan to check-in again.

Other methods for tracking the location of a mobile device include but are not limited to using a local agent residing on a mobile device that uses locally cached location information that is obtained by GPS; triangulation methodologies; and/or signal-strength of the closest cell-phone tower.

The inventory management platform is a tool through which venue operators or other entities charged with selling tickets to an event are able to offer tickets to fans. A “fan” is any person who may be interested in attending an event. A fan may be interested in attending events of a certain type, e.g., baseball games, or events of a particular team, e.g., the New York Mets or New York Yankees, or of a specific music performer or band or events at a particular forum, e.g., Madison Square Garden, or a particular event at a particular location and optionally at a particular day and time. A fan's interest may form his or her fan profile. The fan profile may also include an indication of the types or seats that the fan is willing consider purchasing, e.g., only orchestra seats or only aisle seats. Unless otherwise specified, a fan may be a ticketholder or a person who is not a ticketholder, but who has expressed interest in attending a type of event or a particular event and thus, becoming a ticketholder.

According to some embodiments, the present invention provides methods for offering and delivering perishable inventory to fans Implementation of the method involves two components: (1) a provider determines what perishable inventory is available; and (2) the provider determines to whom to make an offer to purchase this perishable inventory, sends the offer, and if the offer is accepted, delivers the tickets, preferably electronically (or via a link to a website through which they may be obtained) and coordinates receipt of payment.

A provider, which is an entity that operates the inventory management platform, may determine what perishable inventory is available in any of a number of ways. The provider may, for example, be a venue operator or a third party that contracts with the venue operator. In the simplest case, the provider may define the perishable inventory that can be offered as only the inventory that has not been purchased. In order to determine which tickets have not been purchased as of a certain time, the provider may execute a computer program that accesses a database that keeps track of what tickets have been purchased and/or remain to be purchased. Alternatively, the provider may also define the perishable inventory to include both inventory that was not purchased and inventory that was purchased but won't be used, which may be determined by receipt of notice from a ticketholder that he or she won't use one or more of the ticket(s) and/or by recording the failure of a ticketholder to enter an event location or geographic region. In the latter case, a provider may require that by a certain amount of time before an event all ticketholders must confirm their attendance. For example, confirmation of attendance can be tracked by monitoring who is physically at an event, and may be accomplished when each ticket is scanned at a turnstile upon a ticketholder's gaining access to the event or by receiving a message from a mobile device that the ticketholder is in attendance at or will attend the event even if he or she has not yet arrived at the event. The net of this analysis is the determination of the set of tickets containing both tickets for which there are no ticketholders and tickets for which there are ticket holders who have indicated, either directly or by implication, that they will attend an event.

Optionally, for any ticketholder who has not checked-in the provider may send a message asking for confirmation that he or she intends to attend or confirmation that he or she does not intend to attend. In order to receive this confirmation query, the ticketholder must have previously provided a contact email or a cellular telephone number for a device on which an email message, a text message or SMS may be received. Additionally or alternatively, in order to encourage timely check-in for an event, promotions or discounts can be issued to ticketholders who comply.

As persons of ordinary skill in the art will recognize, a fan may purchase a single ticket or purchase and hold tickets for a group of family and/or friends e.g., a block of tickets (e.g., 2-10 tickets). A ticketholder who checks in electronically, e.g. by sending a message confirming attendance, may do so for all members in his or her party, whereas a person who checks in physically may have each ticket scanned—either in paper form or from a digital bar code if displayed on the phone or other electronic device.

In order to determine to whom to send an offer, the provider may look to where, according to its records, fans are at a given time (which may for example be defined as an amount of time prior to an event) and e.g., of what team the potential recipient is a fan, as well as other preferences in a fan profile. As a default, the location may be determined as the last place at which a fan has launched the application on his or her smart phone and allowed his or her location to be updated. Thus, in some embodiments a fan does not need to check-in for a particular event in order to receive an offer to acquire tickets. As persons of ordinary skill in the art will recognize, the system can be designed in a manner such that at regular or irregular intervals, a fan's phone sends a message to the system administering the protocol and provides an update of his or her location without the fan needing to log-in to the application, i.e., the application self-launches for purposes of updating the phone's location. Alternatively, in order to check-in and to update a location, the fan may need to activate an application on his or her mobile device that gives the user the option of sending notice of his or her location to the aforementioned protocol or platform. Additionally, in some embodiments, the system may be configured to weed out fans that already have tickets, thereby, not send offers to those fans.

The information that is sent may, for example, contain content that indicates a precise geographic location, which can be determined through global positioning satellite (GPS) technologies. After receipt of this information, the protocol may calculate the fan's distance from an event. Alternatively or additionally, the message may contain information that indicates that a user is at a designated location such as a particular pre-game get together, a tailgating party, a bar or a restaurant. Furthermore, the protocol may analyze the fan's preference for offers to attend events. These preferences may be stored remotely and accessed by the protocol or received from the fan when he or she checks-in for offers.

If the fan is located within a desired range or at a desired location and is known to be a fan of the relevant team, sport, performer or event, the fan will qualify to receive the opportunity to purchase perishable inventory, e.g., tickets for a limited capacity event. The inventory management platform may offer to sell tickets to all fans within a geographic region or may filter the offers so that only certain fans receive them. By way of an example, the provider may first determine the amount of perishable inventory that is available at one hour before a sporting event. It may then determine which fans are within ten miles of the arena at which the event is to take place and send them an offer to purchase tickets that remain available. The offer may, for example, come in the form of e-mail, a text message, a display on a membership only accessible website, through an SMS message, through a system such as Twitter or a display that is controlled by the aforementioned application. The offer may list classes of tickets or specific tickets, e.g., specific seats that are available. The offer may automatically, or when accessed by a recipient, cause a transformation of a graphic user interface.

The offer may also be configured to provide a means by which the fan can accept the offer. For example, there may be a link attached to an e-mail that brings the fan to an http site. Upon accessing the link, the fan may review the offers and if the fan wishes to accept the offer, specify which and/or how many tickets he or she wishes to purchase and provide an indication of the means for payment. If the initial offer comprised only classes of tickets that are available, upon receipt of a response to an offer, the provider may permit the user to view the location of the seats in order to determine whether they are acceptable and the price of the tickets.

Upon receipt of acceptance from a fan that he or she wishes to attend and receipt of payment (or authorization for payment), the provider will update its database that contains information that corresponds to the availability of tickets, and send to the fan, a confirmation of the purchase, which may comprise an electronic ticket or a set of electronic tickets. The electronic ticket may for example, be in a form that can be printed to a paper copy and/or used in digital format by containing an image that may be scanned or otherwise transmitted, e.g., through near field communication (NFC). The provider may also communicate updates to fans that indicate how quickly tickets are being sold and/or which tickets are being sold. If these updates are provided, they may be sent, for example, at regular or irregular intervals every 1 to 20 minutes or every 2 to 10 minutes or every 3 to 5 minutes. Because a plurality of recipients may receive offers at the same time, the system may be configured to send notifications of the availability of tickets at the time of sending an offer and to verify the continued availability of the tickets at the time that a recipient seeks to purchase or to learn more about available tickets.

If after a certain amount of time, tickets remain not purchased, the provider can cast its net wider and send the offer to fans at a greater distance from the event. For example, if the first zone was ten miles from the event and the offer was made three hours before the event, the second zone may be twenty-miles from the event, and the second offer may be sent one-half of an hour before the start of the event. There may be more than two stages of offerings; however, as a person of ordinary skill in the art will appreciate, the timing of the offerings and the geographic ranges must be balanced against the likelihood of a person being able to get to the event in time to enjoy most or all of it.

Furthermore, the provider may operate its system in a manner that only sells tickets at face value or sells them at a discount, or makes an initial offering at face value, but makes a subsequent offering at a discount. In some embodiments, the system may be configured to auction available tickets.

As a person of ordinary skill in the art will readily recognize, the above-described methods and system show the use of various embodiments of the present invention as applied to providing fans who do not already have tickets with the ability to become ticketholders. However, the system could also be configured to permit ticketholders who have tickets that correspond to seats in a first range, e.g., the mezzanine to purchase tickets in a second range, e.g., the orchestra. In these cases, the current ticketholder's mezzanine tickets could become available for other fans to purchase. In some embodiments, if this feature is offered to ticketholders it may be offered only to ticketholders who have checked in, only to ticketholders who have not checked in or both. Additionally, it may be offered prior to or at the same time that offers are made to fans who have not purchased tickets. By way of further example, the offers to existing fans may be in the form of upgrades at half-time or intermission or in the case of baseball, during or after a particular inning, e.g., first, second, third, fourth, fifth, sixth, seventh, or eighth innings

Furthermore, a series of offerings may be sent to fans of different groups, for example fans with tickets in a first send, then fan with tickets in a second section, and then fans without tickets. In these embodiments, persons who have the second best seats may have the first choice of purchasing the best seats. Thus, the best seats would only become available to persons who have the third best seats after the persons with the second best seats have had an opportunity to upgrade. Finally, the persons without tickets may be provide an opportunity to buy tickets only after everyone who already has tickets has been offered the opportunity.

According to another embodiment, the present invention provides another method for selling ticket inventory to an event. In this method, a provider may determine an inventory of tickets for an event for which at time T1, no ticketholder has indicated that he or she will be in attendance at the event (i.e., tickets that as of T1, will not be used), wherein the event is scheduled for an event time T2 at an event location, wherein T2 is after T1. The provider may set the time between T1 and T2 as any amount of time that it wishes. For example, the time may be up to twenty four hours or between 5 minutes and 12 hours or between 15 minutes and 6 hours or between 30 minutes and 4 hours.

In some embodiments, the provider may determine which tickets are available by, for example, identifying a first set of tickets for an event that form the complete set of tickets for an event regardless of whether they have been purchased (or otherwise indicated as to be used); identifying a second set of tickets, wherein the second set of tickets are the tickets that correspond to a group of ticketholders who have confirmed that they will be or are in attendance at the event; and subtracting the second set of tickets from the first set of tickets to form a third set of tickets. The third set of tickets form the inventory of tickets for which at T1 no ticketholder has indicated that he or she will be in attendance.

In other embodiments, the provider may determine which tickets remain available by: identifying a set of tickets that have not been purchased; identifying a set of tickets that are the tickets that correspond to a group of ticketholders who have purchased tickets for the event and confirmed that they will not be in attendance at the event; and defining the inventory of tickets for which at T1 no ticketholder has indicated that he or she will be in attendance as the combination of these two groups of tickets.

In either of the two aforementioned embodiments, a provider that sells some or all of the tickets to a fan that would otherwise go unused may decide to share some or the entire sale price with the original purchaser of the ticket, if there were one.

The service provider may also identify a set of potential attendees within one or more geographic regions, wherein the set of potential attendees comprises a plurality of persons who have previously confirmed a willingness to receive an offer to the event. This willingness may be deemed to have been confirmed by the user's having indicated that he or she is a fan of a particular team, performer, event, etc. The geographic region may, for example, be defined as a distance from an event. In some embodiments, the distance is set at less than 100 miles away, less than 50 miles away, less than 25 miles away, less than 10 miles away, less than 5 miles away, less than 2 miles away or less than 1 mile away. Alternatively or additionally, the distance may also be defined as requiring that a potential attendee is at least ½ of a mile or at least 1 mile or at least 2 miles or at least 5 miles or at least 10 miles away from the location of an event.

Furthermore, in some embodiments the geographic region may be defined by one or more discrete locations at which a group of persons may congregate. Thus, rather than being measured as a physical distance from an event, it may be determined by the location of a tailgating or pre-party event, which could for example, be located at a specific business establishment, home or park.

From one or more fans, the provider may receive an acceptance of the offer. The acceptance may comprise an identification of a specific number of tickets and optionally, the specific seats to which the tickets apply and may be received over a wired or wireless device from, for example, a computer or smartphone. As persons of ordinary skill in the art will recognize, the tickets may be for general admission and not specify a physical seat (and, in some cases, may be for an event with no physical seating) or they each may specify a row and seat identifier such as a letter and/or number. After acceptance, the provider may transmit to the at least one potential attendee a confirmation that the at least one potential attendee may use the specific tickets to attend the event. The provider may also send a receipt and electronic tickets or means by which to access the electronic tickets.

The method is not limited to any particular type of event. By way of non-limiting examples, the event may be selected from the group consisting of a sporting event, a live theater event, a musical theater event, an opera, a dance recital, a lecture, a charity benefit, a party, a concert and a journey on for example a train, a bus, a boat or an airplane. Additionally and as noted above, the ticket need not be for a specific physical seat or for an event that has any physical seats.

In some embodiments there is a first offering made at or about time T3, which is after T1, to persons who are within a first geographic radius of the event at time T3. At time T4, which is after T3, an offer may be made to persons who are within a second geographic radius to the event, wherein the second geographic radius is greater than the first geographic radius.

In several of the embodiments described above, the set of fans to whom offers are made excludes ticketholders. In other embodiments, the systems are designed such that the plurality of persons to whom offers are made can include fans who are already in possession of one or more tickets of a first class and the offer corresponds to tickets in a second class. Thus, these fans may receive offers by activating an application that enables them to notify the provider that they wish to receive these types of offers. Analogous to the system noted above, these fans may be deemed to have consented to receiving offers for upgrades by having purchased tickets and allowing the system to know that it is a fan, e.g., noting in the application described above that he or she will be at an event.

According to another embodiment, the present invention provides a computer program product comprising a computer readable storage medium having computer useable program code embodied therewith. Accordingly, one or more, if not all of the steps of the methods of the various embodiments may be carried out automatically within a computer system via at least one program executing on computing equipment, wherein the at least one program is stored on a non-transitory storage medium. The computer useable program code may be stored on a non-transient medium that upon being executed by a processor is operable to carry out one or more features of the methods disclosed herein. The code may exist in any language that a programmer can use to cause the claimed methods to carry out their intended functions, e.g., C++ or Java.

A first feature of this embodiment is configured to collect a first set of data that is related to a set of tickets for a limited capacity event. This first set of data may correspond to the complete set of tickets for which attendance is being offered, regardless of whether they have been purchased or are being used. This information may be stored in a database that is operably coupled to or is capable of being operably coupled to the computer program product.

A second feature is configured to collect a second set of data that is related to confirmed attendance of ticketholders for the limited capacity event. This second set of data may be obtained by collecting all of the information that corresponds to ticketholders who have checked-in. By way of example, checking-in may be by having a ticket scanned upon entry into an event.

A third feature is configured to determine a third set of data that is related to tickets for which attendance for the limited capacity event has not been confirmed. A simple algorithm may be used to subtract the second set of data from the first set of data, which generates the third set of data.

A fourth feature is configured to disseminate information corresponding to the third set of data to a plurality of persons on their mobile devices at a predetermined amount of time prior to the start of the limited capacity event. The plurality of persons may be defined by their geographic location and their having implicitly expressed intent in receiving an offer. This geographic location may, for example and as described above, be determined by a distance from the event.

A fifth feature is configured to receive from at least one of the plurality of persons, an indication that the at least one person would like to purchase a ticket for the limited capacity event. If two or more persons express interest in the same tickets, the program may allow the tickets to be purchased on a first come first serve basis or the program may conduct an automated auction. Optionally, the instructions may be configured to receive payment information such as credit card or debit card information. Each of the five aforementioned features may be part of a computer program product in the form of modules that are operably coupled to each other.

The computer program product may further be configured to communicate with a payment processing module. A payment processing module is a module that is capable of receiving information to enable payment for a transaction and/or to communicate with a third party issuer, payor or other entity that facilitates payment. By way of a non-liming example, payment may be coordinated through technologies such as those employed by PayPal® or other similar payment processing entities.

In various embodiments, the systems, methods and computer program products of the present invention target offers that are based in whole or in part on a fan's passion for a sports, event or team. A fan's passion may be measured by one or more of how often the fans tweets, posts on social media web-sites, attends events such as tailgating events or other events for fans or the number of fan friends that he or she has. A provider may attribute a value to each action that it defines as being indicative of a fan's passion (e.g., each instance of posting on social media) and develop an algorithm that computes one or more of these variables, which may be weighted or unweighted, thereby generating a passion score for each fan. The score may be updated each time that a fan activates his or application or does a passion scoring action. Alternatively or additionally, the system may, for all fans, update scores at regular intervals or immediately (or within a few minutes) before sending an offer to fans.

Thus, under certain conditions, the provider may send an offer to any fans who have demonstrated a certain level of passion or to fans within a certain geographic region who have demonstrated a certain level of passion. The level of passion sufficient to merit a particular offer may be objective. Thus, whether a particular fan receives an offer is not dependent upon the levels of passion demonstrated by other fans. Alternatively, the level of passion may be relative, and thus the fans who have the top 50% or top 40% or top 30% or top 20% or top 10% of passion levels within a geographic region may receive the offer.

As persons of ordinary skill in the art will recognize, the use of passion levels to determine to whom to make an offer may be used in combination with limited capacity goods and geo-fencing; however, it need not be used in combination with both or either of those strategies. Thus, in some embodiments, the present invention provides a method for offering goods or services to a set of persons, wherein the set of persons is defined in part or in whole by their history of passion for the goods or services. Optionally, when making a determination of potential customers to make the offers, a provider may take into account the passion and location of each of the potential customers.

Accordingly, in another embodiment the present invention provides a method that is directed to targeting offers for commercial transactions relating to a good, a service or an opportunity. This method comprises: (a) determining a set of potential customers for a good, a service or an opportunity; and (b) analyzing data associated with the potential customers in order to determine to whom to make an offer. The good, the service or the opportunity may or may not be to a limited capacity event. In some embodiments, even if not for a limited capacity event, there may be either a limited number of offers or a limited amount of time in which to accept the offer.

In this method, one analyzes data associated with each person within the set of potential customers, wherein the analyzing comprises generating a passion score by an algorithm for measuring passion. The algorithm comprises at least one variable selected from the group consisting of activity in social media pertaining to the good, the service or the opportunity; transmission of messages pertaining to the good, the service or the opportunity; visits to websites pertaining to the good, the service or the opportunity; prior purchases of the same or similar goods, services or opportunities, and the number of fan friends that he or she has. Thus, a passion score is a measure of prior demonstrated enthusiasm. A “fan friend” refers to the number of friends on a social media site who are fans of the same good, service or opportunity.

As with other methods of the present invention, this method may determine a set of fans to whom to make an offer for the good, service or opportunity by either a predetermined number of fans who have the top passion scores or a predetermined percentage of fans who have the top passion scores.

Finally, according to the method one transmits the offer to the set of fans identified by their passion scores. Optionally, the offers may be sent only to persons within a defined geographic radius.

By establishing a framework in which a provider considers the passion level of potential customer, a provider (which may include vendors as well as performers) will encourage potential customers (who may be considered fans of a product, service, team, event or genre) to become more active and to demonstrate their passion. Thus, there is increased marketing of the good, service or opportunity.

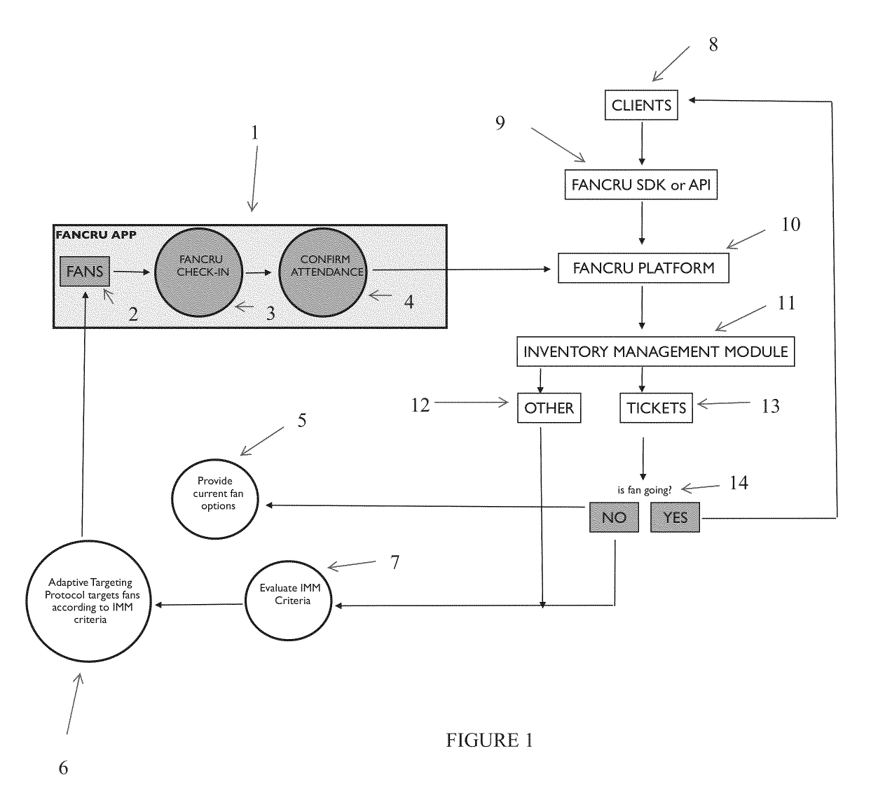

Various embodiments of the present invention may be further understood by reference to FIG. 1. As shown in the figure, a user may have an application (or APP) on his or her mobile device 1. The APP may be located on the device of each of a plurality of fans 2. A fan who does not have a ticket or who does have a ticket may check-in through the APP 3. (As shown in the figure, the same APP is used by fans who have and fans who do not have tickets; however, optionally separate APPs can be used for these features.) The fan who does not have a ticket may check-in at a tailgating event or at a distance from a sporting event or at the event. A fan who does already have a ticket or tickets, may, at that time, confirm that he or she will attend an event 4. A message is then transmitted to an inventory management platform denoted FANCRO PLATFORM in the figure, that is configured to receive the message confirming that the fan wishes to attend or if already a ticketholder will attend 10.

Upon receipt of the message, the platform may update a database through an inventory management module 11. Two types of information may be considered: tickets 13 and other information 12. If a message regarding the tickets is received from a current ticketholder, the system may register that a fan will attend the event or that the fan has indicated that he or she will not be in attendance 14.

The platform notifies clients e.g., venue operators, who may aggregate data and who may update their databases 8. A client may communicate through an SDK and or API developed program 9 to the platform 10 that its database has been updated and what the status is of the inventory. The client can also communicate any special promotions or discounts that it wishes to offer at that time.

If the fan has tickets but is not going to attend, then the inventory management module may provide options to the current fan such as to meet up with other fans 5. The inventory management module may also evaluate its criteria 7 and depending on the number of outstanding tickets engage in adaptive targeting protocols 6 that offer to other fans, the tickets that a ticketholder won't be using. These protocols may, based on the volume and character of purchase, change or expand the geographic range in which fans will be offered tickets. Optionally, they may also take into account the passion level of fans.

The inventory management database may also consider other information 12 from fans who have checked in but who don't have tickets. This information may, for example, include the prospective ticketholder's location and/or desired number of tickets. The platform may then again evaluate inventory management module criteria 7, and engage in adaptive targeting protocols that target fans according to criteria within the inventory management module.

The methods of the current invention may be embodied in one or more protocols that are stored in one or more executable computer program products and tools for creating these technologies may be embodied in a software development kit. The computer program products may, for example, be stored as part of software, hardware or a combination thereof in a non-transitory computer readable storage medium. Furthermore, various embodiments of the present invention may be parts of systems that comprise one or more mobile devices and one or more servers. The mobile devices may be configured to communicate with one or more servers through technologies that are now known or that come to be known to persons of ordinary skill in the art for accessing a server through a network such as the worldwide web.

For example, a service provider may be or be operably coupled to a network-addressed entity that provides web services. It may be configured to interface with one or more back-end systems, such as an inventory managed system, an event management system, an accounting system and a communication system. It may also be configured to interface with e-commerce applications.

Various embodiments of the preset invention may be carried out on a network that comprises hardware, software and firmware necessary to convey data that is encoded within carrier waves. The data may, for example, be contained within analog or digital signals and conveyed through data channels. The network may also comprise equipment such as routers, data lines, hubs, intermediary servers, circuit-based communication components, and mobile communication components.

The phrase “non-transitory tangible computer readable storage medium” as used herein may also be referred to as a computer program product, and includes hardware, software or a combination of the two on which one may store a set of instructions that may be used to direct a computer to perform a set of steps. Examples of non-transitory tangible computer readable storage media include, but are not limited to, a hard drive, a hard disk, a floppy disk, a thumb drive, a computer tape, ROM, EEPROM, nonvolatile RAM, CD-ROM and a punch card. Thus, in some embodiments the instructions described above are software stored on a medium that can instruct a computer having one or more of the following hardware components: memory, storage, an input device, an output device and a central processing unit.

The term “module” as used in this disclosure refers to a computer program product that may be stored on hardware and/or software that may be activated by a user to carry out a defined set of steps and/or to prompt a user to provide information through, for example, a graphic user interface and/or input/output device. Thus, a module may be stored in the form of a tangible medium. For convenience, various features are described herein as being different modules. However, as persons of ordinary skill in the art will readily recognize, different modules may be part of the same of different computer program products that are configured to interact with each other.

Additionally, the methods, systems and computer program products are preferably configured such that any data that is collected, transmitted and/or saved is appropriately protected against undesirable invasions of privacy. For example, the systems can be designed such that only authorized personnel have access to any data that is collected, and/or the data is automatically deleted after a predetermined amount of time, e.g., two weeks, one month or six months. Alternatively or additionally, data may be collected and rendered anonymous for performance of certain types of analytics.

Any of the features of the various embodiments described herein can be used in conjunction with features described in connection with any other embodiments disclosed unless otherwise specified. Thus, features described in connection with the various or specific embodiments are not to be construed as not suitable in connection with other embodiments disclosed herein unless such exclusivity is explicitly stated or implicit from context.

We claim:

1. A method for selling ticket inventory to an event, wherein the method comprises:
(a) determining within a computer system, an inventory of tickets for an event for which at time T1, no ticketholder has indicated that he or she will be in attendance at the event, wherein the event is scheduled for an event time T2 at an event location, wherein T2 is after T1;
(b) determining, via at least one program executing on computing equipment, a set of potential attendees for the event, wherein the at least one program is stored on a non-transitory storage medium;
(c) transmitting an offer for tickets to the event to a subset of potential attendees, wherein the subset is defined at least in part based on a geographic distance from the event; and
(d) receiving an acceptance of the offer from at least one of the subset of potential attendees.

2. The method according to claim 1, wherein the subset is further defined by a passion level.

3. The method according to claim 2, wherein the passion level is measured by applying a computer program product that comprises an algorithm that comprises at least one weighted or unweighted variable selected from the group consisting of attendance at prior events related to a team, a person, a sport or a genre; activity on a social media website directed to the team, the person, the sport or the genre; messages sent related to the team, the person, the sport or the genre; prior purchases related to the team, the person, the sport or the genre; and number of fan friends related to the person, the sport or the genre.

4. The method according to claim 1, wherein the inventory of tickets for which no ticketholder has indicated that he or she will be in attendance comprises tickets that were not previously purchased.

5. The method according to the claim 4, wherein the inventory further comprises tickets that a ticketholder purchased but indicated that he or she will not use.

6. The method according to claim 1 further comprising transmitting an electronic confirmation of the specific number of tickets having been purchased.

7. The method according to claim 1, wherein T1 is up to twenty-four hours before T2.

8. The method according to claim 1, wherein the event is selected from the group consisting of a sporting event, a live theater event, a musical theater event, an opera, a dance recital, a lecture, a charity benefit, a party and a concert.

9. The method according to 1, wherein the determining comprises causing the at least one program to execute the following steps:
(a) identifying a first set of tickets for an event;
(b) identifying a second set of tickets for the event, wherein the second set of tickets are tickets that correspond to a group of ticketholders who have confirmed that they will be or are in attendance at the event; and
(c) subtracting the second set of tickets from the first set of tickets to form a third set of tickets, wherein the third set of tickets form the inventory of tickets for which at T1 no ticketholder has indicated that he or she will be in attendance.

10. The method according to 1, wherein the determining comprises:
(a) identifying a set of tickets for the event, wherein the set of tickets are tickets that correspond to a group of ticketholders who have purchased tickets for the event and confirmed that they will not be in attendance at the event; and
(b) defining the inventory of tickets for which at T1 no ticketholders have indicated that they will be in attendance as the combination of the set of tickets that have been purchased for the event and for which ticketholders have confirmed that they will not be in attendance and a set of tickets that were not purchased.

11. The method according to claim 1, wherein the geographic distance is less than fifty miles.

12. The method according to claim 1, where the offer in step (c) is first made to a persons who are within a first geographic distance to the event at time T3 and at time T4, which is after T3, the offer is made to persons who are within a second geographic distance to the event, wherein the second geographic distance is greater than the first geographic distance.

13. The method according to claim 12, wherein the first geographic distance is less than twenty miles and the second geographic distance is less than fifty miles.

14. The method according to claim 1, wherein the subset of potential attendees comprises persons who are in possession of one or more tickets of a first class and the offer corresponds to tickets in a second class.

15. A computer program product comprising a computer readable storage medium having computer useable program code embodied therewith, wherein the computer useable program code is stored on a non-transitory medium that upon being executed by a processor is operable
(a) to collect a first set of data related to a set of tickets for a limited capacity event;
(b) to collect a second set of data related to confirmed attendance of ticketholders for said limited capacity event;
(c) to determine a third set of data related to tickets for which attendance for said limited capacity event has not been confirmed;
(d) to disseminate information corresponding said third set of data to a plurality of persons on their mobile devices, at a predetermined amount of time prior to the start of the limited capacity event, wherein said plurality of persons is defined, at least in part, by their geographic location; and
(e) to receive from at least one of said plurality of persons an indication that said at least one person would like to purchase at least one ticket for said limited capacity event.

16. The computer program product of claim 15, wherein the geographic location is measured by a distance from the limited capacity event.

17. The computer program product of claim 16, wherein said plurality of persons in (d) are further defined by a passion level.

18. A method for targeting offers for commercial transactions relating to a good, a service or an opportunity comprising:
(a) determining a set of potential customers for a good, a service or an opportunity;
(b) activating a computer program product that comprises a protocol for analyzing data associated with a plurality of persons within the set of potential customers, wherein said analyzing comprises generating a passion score by an algorithm for measuring passion, wherein the algorithm comprises at least one variable selected from the group consisting of activity in social media pertaining to the good, the service or the opportunity; transmission of messages pertaining to the good, the service or the opportunity; visits to websites pertaining to the good, the service or the opportunity; prior purchases of the same or similar goods, services or opportunities; and number of fan friends;
(c) identifying a set of fans from within the set of potential customers to whom to make an offer for the good, the service or the opportunity that is defined in whole or in part as either a predetermined number of fans who have the top passion scores or a predetermined percentage of fans who have the top passion scores; and
(d) transmitting the offer to the set of fans identified in (c).

19. The method according to claim 18, wherein in (c) the offer is sent only to fans within a predetermined geographic region.

20. The method according to claim 18, wherein the offer is for a limited capacity event.
